(19) United States
(12) Patent Application Publication
(10) Pub. No.: US 2002/0088855 A1
(43) Pub. Date: Jul. 11, 2002

(54) Point of sale activation for software and metered accounts

(76) Inventor: Mark B. Hodes, Memphis, TN (US)

Correspondence Address: BUTLER, SNOW, O'MARA, STEVENS & CANNADA PLLC, 6075 POPLAR AVENUE, SUITE 500, MEMPHIS, TN, 38119, US

(21) Appl. No.: 10/038,415

(22) Filed: Jan. 3, 2002

Related U.S. Application Data
(60) Provisional application No. 60/260,058, filed on Jan. 5, 2001.

(51) Int. Cl. G06F 17/60

(52) U.S. Cl. 235/385

(57) ABSTRACT

A packaged delivery system and method are provided for point-of-sale activation for delivery of products or services. The packaged delivery system includes a package, at least one component related to the products or services and retained within the package when closed, and a card secured to the package. The card has an exposed data-encoded portion, accessible at a point of sale, that allows the activation process to begin through a point-of-sale activation device. The card further includes a personal identification number (PIN) associated with the control number and the products or services. The corresponding method includes the steps of: using a point-of-sale activation device to transmit a number associated with the goods or services; then activating a PIN by a processing apparatus; and then activating delivery of the goods or services by the processing apparatus.

### CROSS REFERENCE TO RELATED APPLICATIONS

This application claims the benefit of 35 U.S.C. section 119(e) based on provisional application serial No. 60/260,058 filed Jan. 5, 2001 hereby incorporated herein by reference in its entirety.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to methods and apparatus for point-of-sale activation of software and metered accounts, and related packaging for apparatus therefor. This invention is related to the invention disclosed in Fiala et al., U.S. Pat. No. 5,918,909 (issued Jul. 6, 1999) for a Package for Card with Data-Encoded Strip and Method of Using Same, fully incorporated by reference herein.

### BRIEF SUMMARY OF THE INVENTION

This invention is a point-of-sale activated download package with data-encoded magnetic strip and related item or items. Once purchased, the Personal Identification Number (“PIN”) or PINs associated with the encoded data are activated. The owner or purchaser of the then-activated PIN or PINs, by accessing an appropriate device or website and providing the active PIN or PINs and other required information, then receives access to access codes, keys, goods and services, or software program or files authorized and delivered after registration. Once received, the data or information allows the full value or use of the product purchased. This packaged card and related products provide a delivery system that allows inactive product sales, prepaid authorized delivery of licensed software programs, digital information, and/or goods and services provided over the Internet, satellite communications, cable, fiber optics and all means of communications available today.

This invention is a package delivery system design that associates PINs with goods and services activated at point of purchase. The package can include a billboard for graphic presentation, a card, and can include one or more packaged components related to the offered goods and services. PIN or PINs are activated at point of purchase by using a magnetic strip, bar code, or chip included on a card attached to the package or within the package. PINs can also be activated and delivered by a device capable of producing a PIN or PINs at the point of purchase. A kiosk would be considered as such a device. That type of device can be programmed with active PINs and only printed and delivered after purchase. With the package delivery system, prior to purchase the PIN or PINs are inactive or of little or no value as related to the goods or services provided after purchase. Inactive—“Cold inventory” prevents unauthorized use of a product until purchased or activated—“Hot inventory.” This feature ensures that goods or services offered for sale cannot be used or copied without first being purchased. Additional security measures are not necessary because theft, pirating, copying, or transferring the goods and services is made more difficult. The invention provides a method of validation providing license control of goods and services by requiring a secure PIN and other specified PIN or PINs associated with items or components included in the packaging when authorization or registration is required. The delivery system also offers a method of activating smart card technology used for accessing or allocating software programs, broadcast technologies such as television programming, access to virtual programming on the Internet, or other goods and services. The delivery system provides a means of activation that turns, after purchase, a cold or inactive PIN or PINs, or smart chip into a hot or active PIN or PINs and/or active smart chip. By providing an active PIN or PINs and other required information to an appropriate device, such as a computer connected to the Internet and a specified web address, authentication takes place. Once authenticated, codes or encrypted codes or other data, file, programs, information, or encrypted data keys can be delivered by means of any communication available today to enable the buyer the full use of the product, software, information, goods and services, virtual programming or entertainment purchased.

### BRIEF DESCRIPTION OF THE SEVERAL VIEWS OF THE DRAWING

FIG. 1 Inside-package view of the present invention showing a package secured to a first card and a positioned CD.

FIG. 2 Illustrates the front panel and the rear panel of the package prior to the adhesive being applied or the heat-activated material bonding the front panel to the back panel and including an attached film window and position CD in a formed film window. All drawings such as FIG. 2 do not require a hinge such as is represented.

FIG. 3 Illustrates the completed phase of FIG. 2.

FIG. 4 Illustrates the front view of the package having a hanger hole or aperture and an attached first card.

FIG. 5 Illustrates the back of the package having an exposed data-encoded strip with serialized CD or related component included in the package.

FIGS. 6, 12, 22, 39, 45, 53 and 63 Illustrates the inside view of the front panel and the back panel of the package. The package can be any size and can have a bar code and aperture or apertures.

FIGS. 7, 13, 23, 29, 40, 46, 57, and 63a The drawing represents a formed PVC transparent pocket or blister used to hold the CD or related component.

FIGS. 8, 16, 24, 32 Illustrates a CD or computer disk that can be of any size or shape.

FIGS. 9, 14, 25, 30, 42, 48, 58, and 65 the drawing represents a protective Mylar or film window.

FIGS. 10, 15, 26, 31, 43, 49, 59, and 66 Illustrates the front of a first card with an attached or embedded smart chip.

FIG. 11 illustrates a first card with a magnetic strip and a partially obscured PIN.

FIG. 17 Inside-package view of the present invention showing a package secured to a first card with a smart chip and a positioned CD. A panel of the package has a die-cut aperture to expose a bar code on the CD.

FIG. 18 Illustrates the front panel and the rear panel of the package prior to the adhesive being applied or the heat-activated material bonding the front panel to the back panel and including an attached film window and position CD in formed blister and an aperture to expose a bar code. The drawing also includes a card with a smart chip attached to a panel.

FIG. 19 Illustrates the front panel and the rear panel of the package after the adhesive being applied or the heat-activated material bonding the front panel to the back panel. The package has an attached first card with a smart chip and including an attached film window and positioned CD in a formed blister and apertures to expose bar code.

FIG. 20 Illustrates the front view of the package having a hanger hole or aperture and an attached first card with an attached smart chip.

FIG. 21 Illustrates the back of the package having a card with an exposed data-encoded strip with serialized CD or related component included in the package. The CD or related component has an exposed bar code and the first card has obscured PINs and a web address, human-readable control number, serial number and bar code.

FIGS. 27, 44, 60, 82 The back of a first card including partially obscured PIN or PINs, a related bar code, human-readable serial number, control number and data-encoded magnetic strip.

FIG. 33 Illustrates the inside of the front panel and the rear panel of the package prior to the adhesive being applied or the heat-activated material bonding the front panel to the back panel and including an attached film window and blister. Also included in this illustration are any multiple of cards or labels having a PIN or PINs contained in the attached blister and associated to the magnetic strip or code on the attached card that can have a smart chip. All drawings such as FIG. 33 do not require a hinge such as is represented.

FIG. 34 Illustrates the front view of the package having a hanger hole or aperture and an attached first card with an attached smart chip. The drawing also illustrates the formed blister with any number of associated cards with PINs.

FIG. 35 Illustrates the back of the package having first card and an exposed data-encoded strip with obscured PINs and human-readable numbers and a web address. The related cards in the formed blister have a bar code accessible through a die-cut aperture.

FIG. 36 Illustrates the inside of the front panel and the rear panel of the package prior to the adhesive being applied or the heat-activated material bonding the front panel to the back panel and including an attached film window and blister. Also included in this illustration are any multiple of cards or labels having a PIN or PINs contained in the attached blister and associated to the magnetic strip or code on the attached card that can have a smart chip attached within the perimeter of the panel. All drawings such as FIG. 36 do not require a hinge such as is represented.

FIG. 37 Illustrates the front view of the package having a hanger hole or aperture and an attached first card with an attached smart chip positioned within the perimeter of the package. The drawing also illustrates the formed blister with any number of associated cards or labels with PINs.

FIG. 38 Illustrates the back of the package having card within the perimeter of the package and an exposed bar code through a die-cut aperture. The related cards in the formed blister have a bar code accessible through a die-cut aperture.

FIGS. 41, 47 Illustrates a front view of multiple cards stacked prior to be included in the formed blister. The cards may or may not have a smart chip.

FIG. 50 Illustrates the front panel and the rear panel of the package prior to the adhesive being applied or the heat-activated material bonding the front panel to the back panel and including an attached film window and positioned box formed film window. All drawings such as FIG. 50 do not require a hinge such as is represented. A card is included and attached and has a smart chip but, does not require a smart chip.

FIG. 51 Illustrates the front view of the package having a hanger hole or aperture and an attached first card with an attached smart chip. The drawing also illustrates the formed blister with a box.

FIG. 52 Illustrates the back of the package having first card and an exposed data-encoded strip with obscured PINs and human-readable numbers and a web address.

FIG. 54 A book, manual or publication having an attached bar code and human-readable numbers.

FIGS. 55, 64 A box or container with a bar code and human-readable numbers or without a bar code and human-readable numbers.

FIG. 56 A floppy disk with a bar code and human-readable numbers or without a bar code and human-readable numbers.

FIG. 61 Illustrates a side view of a package and blister containing a box. The box may have a bar code attached.

FIG. 62 Illustrates a box with a manual or publication.

FIG. 67 Inside-package view showing a package secured to a card with a smart chip and a positioned CD in blister. A panel of the package has a die-cut aperture to expose a bar code on the CD.

FIG. 68 Illustrates the front panel and the rear panel of the package with a card and chip attached within the perimeter of the package prior to the adhesive being applied or the heat-activated material bonding the front panel to the back panel. A CD having a bar code or codes, in formed film blister and an aperture to expose a bar code on the CD.

FIGS. 69, 70 Illustrates the front panel and the rear panel of the package after the adhesive being applied or the heat-activated material bonding the front panel to the back panel. The package has an aperture to expose a bar code and a hanger hole.

FIG. 71 Illustrates the back of the package having a hanger hole, a CD having a bar code and serialized number. The view also illustrates a bar code on a card within the perimeter of the panel, exposed through an aperture.

FIG. 72 The front view of package with a disk and an attached card and smart chip. The package is a single panel or ply.

FIG. 73 The back view of a single ply package with a hanger hole and apertures exposing bar codes.

FIG. 74 Illustrates an example of a geometric shape attached to a card with a magnetic strip and obscured PINs, a bar code and human-readable text. The folding carton itself is a straight tuck design and is commonly known to the carton industry. There are additional panels attached to the carton, one panel attached to the card further illustrate the creativity allowed by the invention. An aperture is also included and is an example of how any type of related part, toy, game board, or set of publications can be associated by a bar code in manufacturing. There can be any number of apertures to expose any number of bar codes. Note that the card is attached having the front panel to the back panel of the carton.

FIG. 75 Illustrates how the carton is folded to allow the glued seam to finish the sleeve portion of the carton without removing the card from the panel.

FIG. 76 Illustrates how the carton panels can be unfolded at point of purchase such that the card is not removed from the panel and the magnetic strip can be read or related bar code scanned.

FIG. 77 Either opening in the glued sleeve portion of the carton can be used to insert the related component or components, providing the bar code or codes are oriented to and exposed by the aperture or apertures. The tucks can be closed after the sleeve has been filled by the contents.

FIG. 78 Illustrates a single ply package or billboard with a hanger hole, attached to a card having a smart chip. The package has a fold, score or perforation used to allow a magnetic strip to be read at the point of sale without removing the attached card.

FIG. 79 Is the back view of a single ply package with a hanger hole and a fold, cut score, or perforation.

FIG. 80 Is a side view of a single ply package with a fold, score, or perforation attached to a card.

FIG. 81 Is a side view of a single ply package with a card and being folded or bent in a direction away from the card to allow the magnetic strip to be read. The package is being bent away at the fold, cut score or perforation.

FIG. 82 Is a card back having more than one PIN number, magnetic strip, serial number, a control number and a bar code that can be related to the control and PIN number or numbers. In this view the PINs are only partially obscured by a tamper-evident pressure-sensitive adhesive label but can be completely obscured.

FIG. 83 Is a card that has all of the elements of FIG. 82 with the exception of the web address used by the purchaser to register the active PIN or PINs. Valid data input at registration will initiate the delivery of the method or tool allowing full use of the purchased product. The PINs illustrated are only partially obscured by an opaque materials applied by know methods of application and shown to be partially removed by scratching. The PINs can be completely obscured in a similar fashion.

FIG. 84 Is a transparent or opaque pressure-sensitive label.

FIG. 85 Is a drawing of FIG. 84 after a random PIN and a control number related to the PIN and a bar code have been printed on the material.

FIG. 86 Represents FIG. 85 having had an opaque material applied to obscure the PIN.

FIG. 87 Illustrates the opaque material being scratched off the PIN to reveal the number and to provide evidence of tampering for the purchaser.

FIG. 88 Illustrates a single label with more than one obscured PIN or PINs, related control numbers and related bar codes. These labels can be machine applied to any related component of the package including a card, providing authentication of the components at the time of registration.

FIG. 89 Illustrates a package with an attached card and a device or apparatus used to read a magnetic strip and transmit the information on the magnetic strip, at the point of purchase. The device can also receive data.

FIG. 90 Illustrates an apparatus or an appropriate device used to transmit magnetic strip encoded data to a receiving device.

FIG. 91 Illustrates a device used to receive the encoded data and forward the data as described in FIG. 90. These types of devices can be independent or built into other devices or apparatus.

FIG. 92 Illustrates a device or apparatus used to activate, switch, meter, or decrement the account or accounts, PIN or PINs, or initiate the delivery of the data provided that allow the full value or use of the service or goods delivered. This device can also understand the relationship of the control number to that of the PIN or PINs as this device could have been the, or one of the computers used to generate the PINs and/or the control numbers.

FIG. 93 Illustrates a device similar to that described in FIG. 91. These types of devices can be independent, built into other devices, or apparatus. This device can be used to send information or receive information.

FIG. 94 Illustrates an apparatus used to receive and transmit information in a similar fashion to that of FIGS. 90, 91, 93, and 94.

FIG. 95 Illustrates the type of device or an appropriate apparatus or a computer, personal computer, or television or that will receive the delivered value or utility, good or service provided by the invention to the consumer.

FIG. 96 Illustrates a computer or main frame or facility receiving the authorization from the magnetic strip establishing that the product has been purchased at the point of sale, and delivering the data, activation, authorization, information, code or encrypted codes or goods and services expected. The information expected would allow by itself or with information on related components the full use of the product purchased.

### DETAILED DESCRIPTION OF THE INVENTION

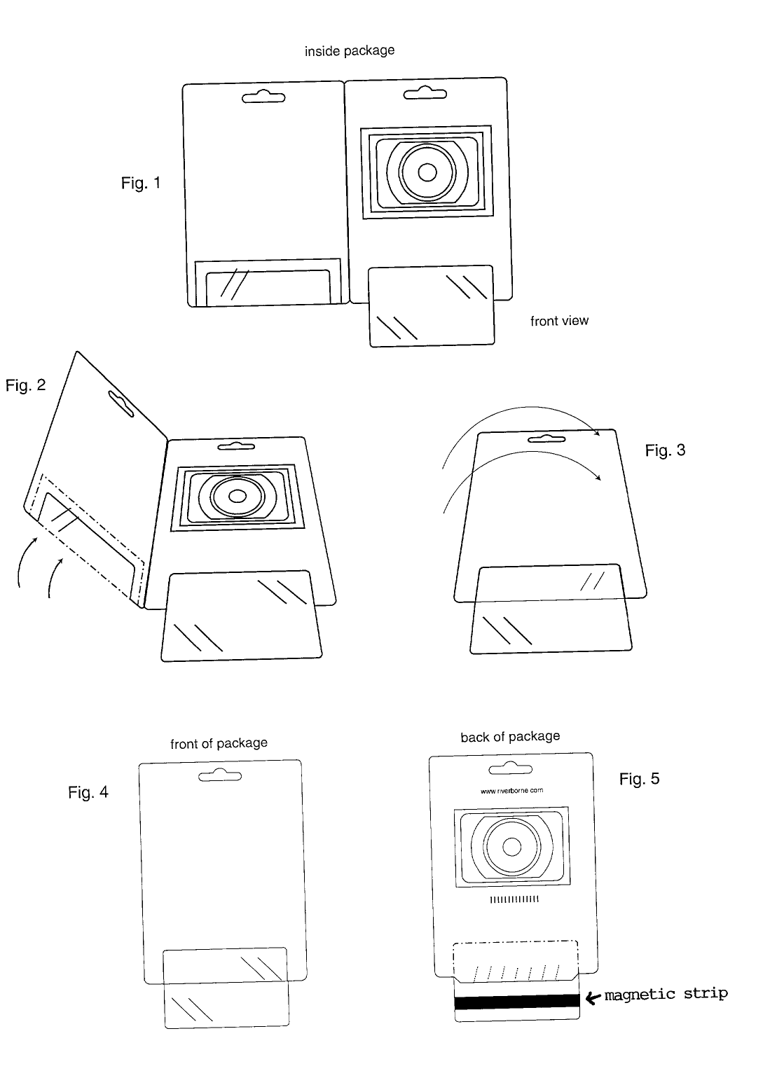

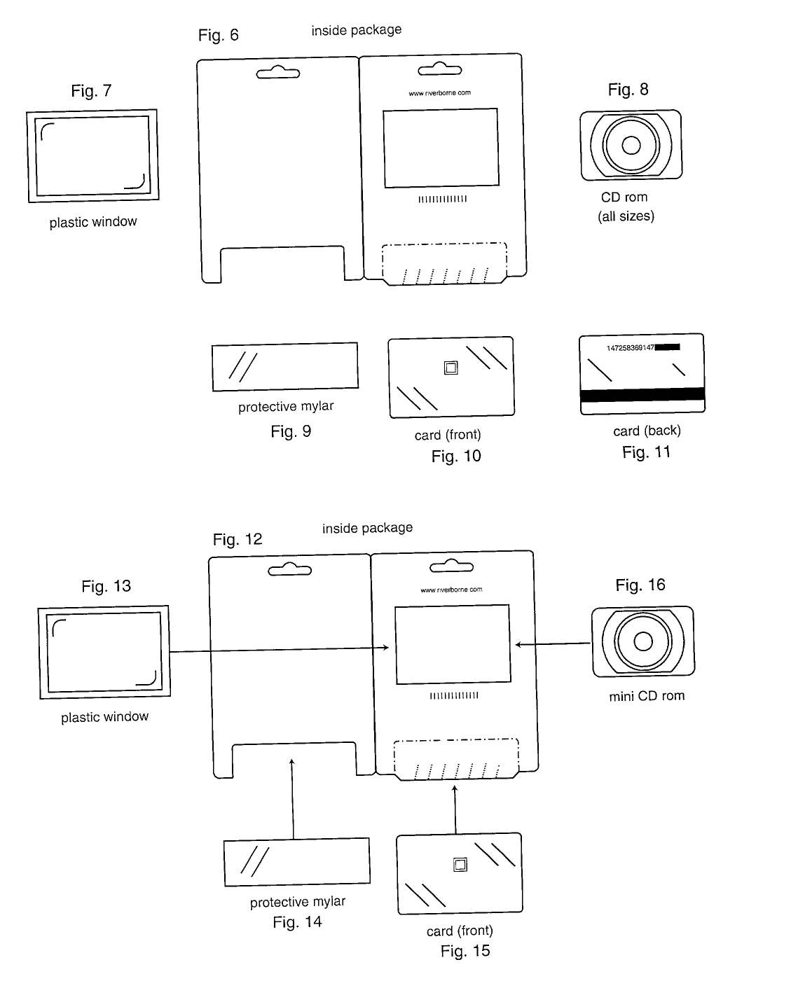

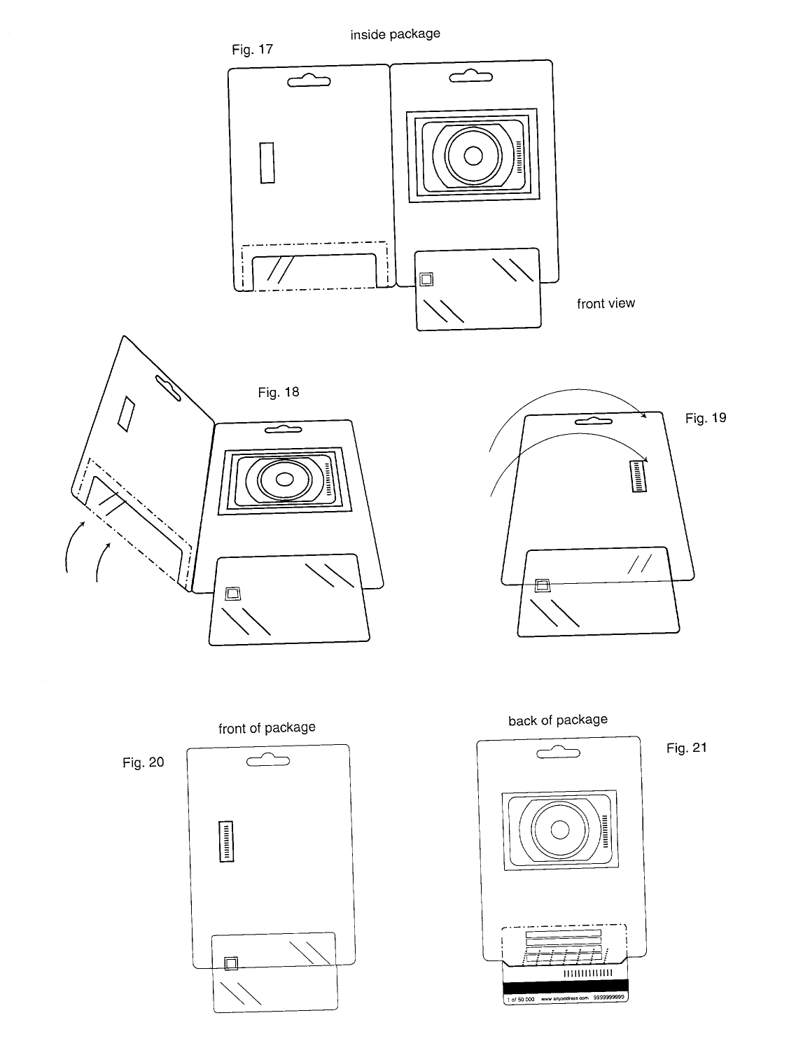

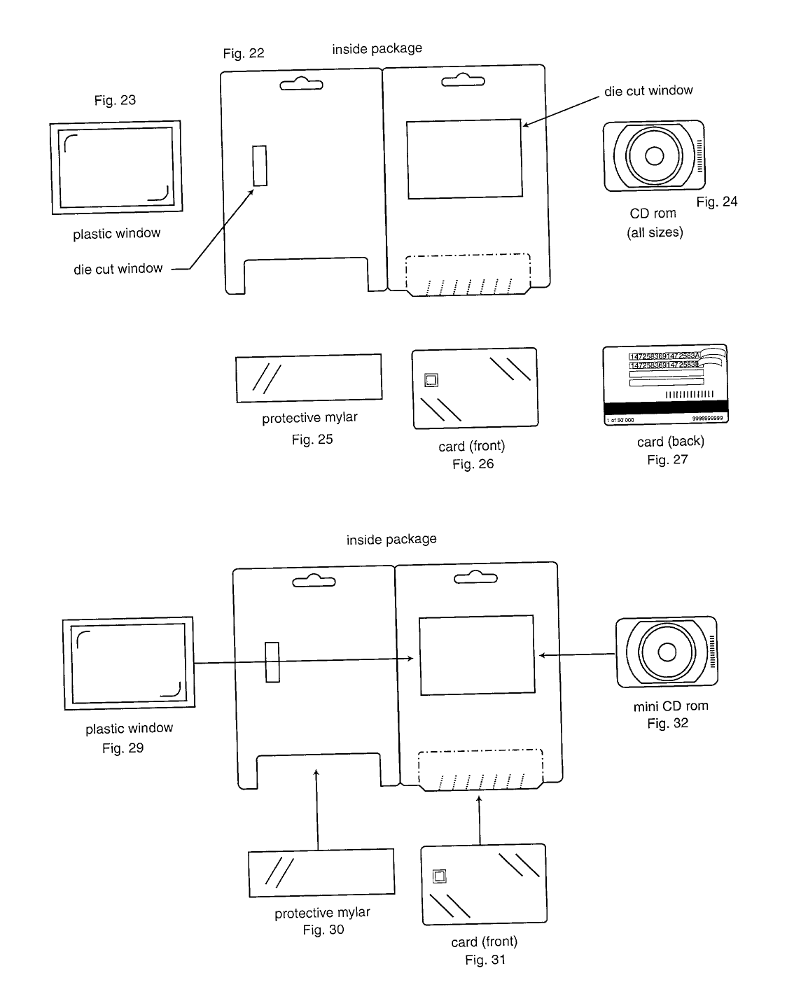

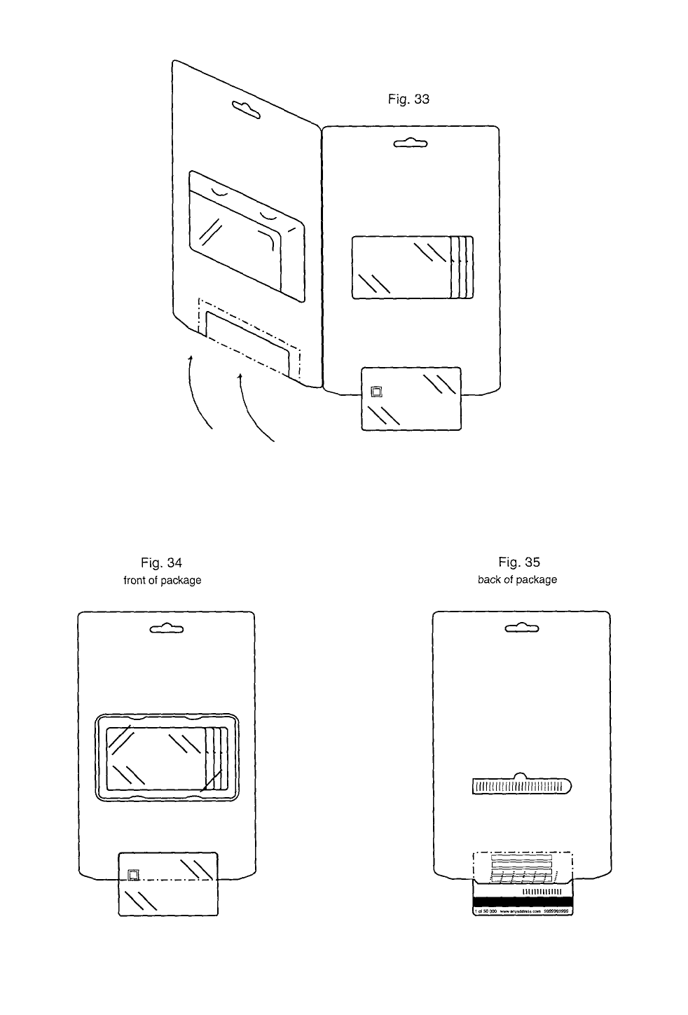

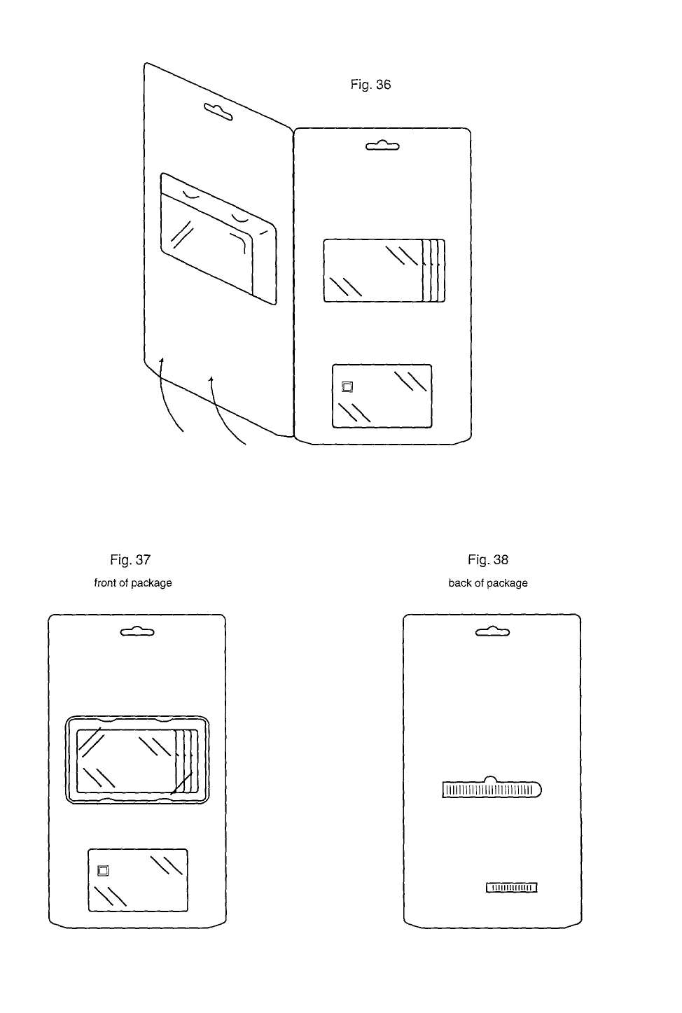

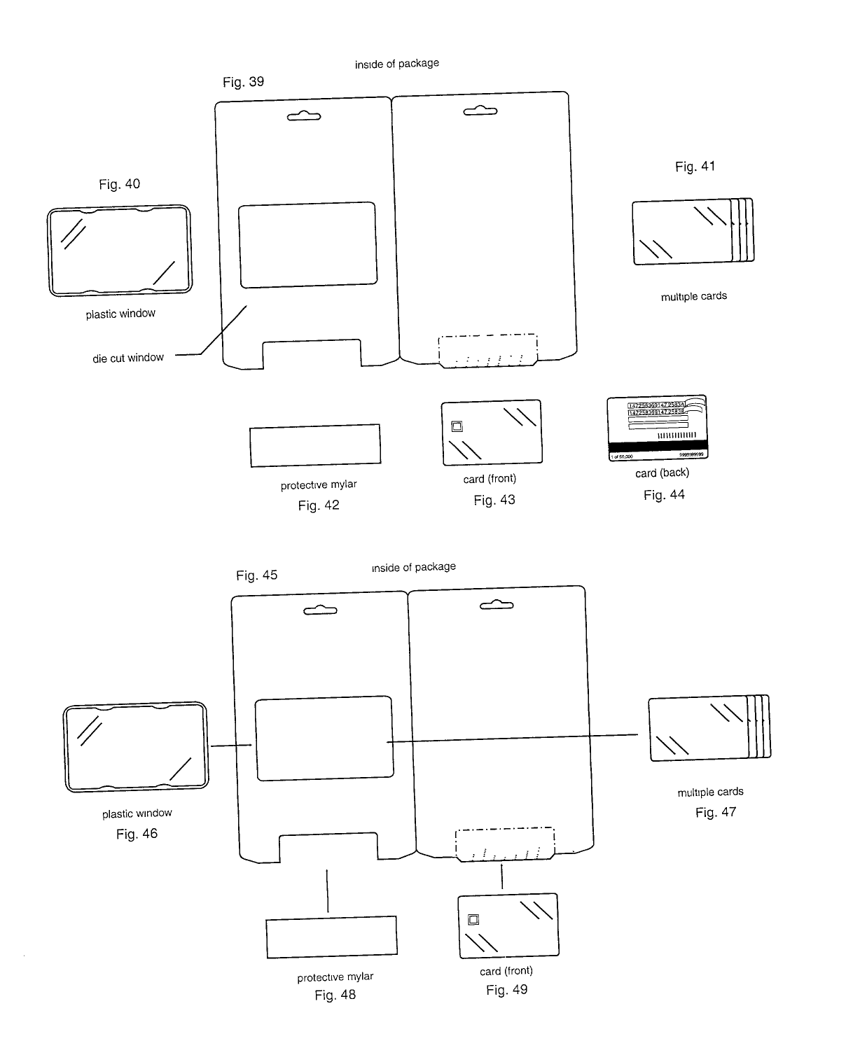

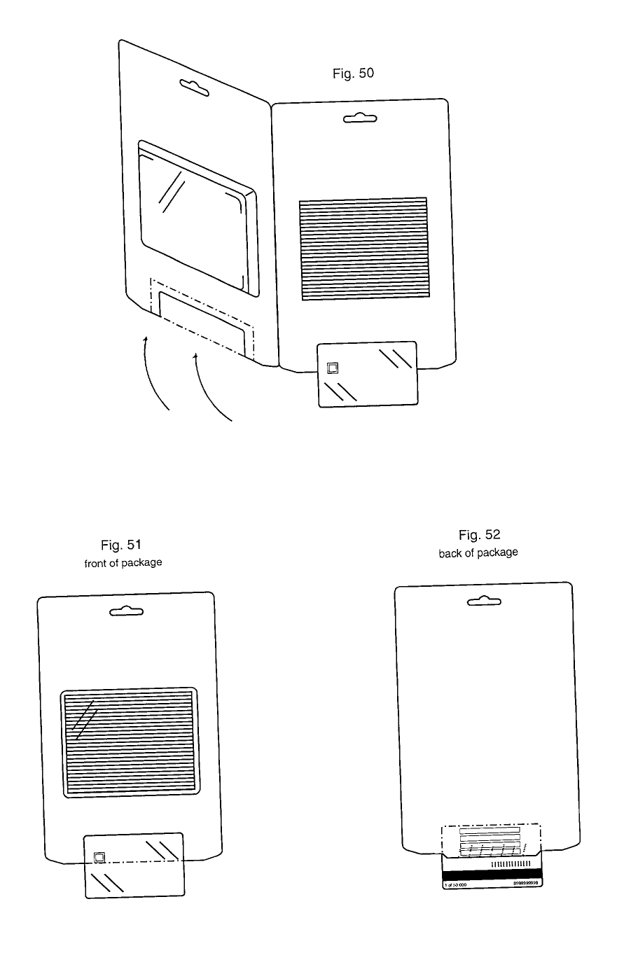

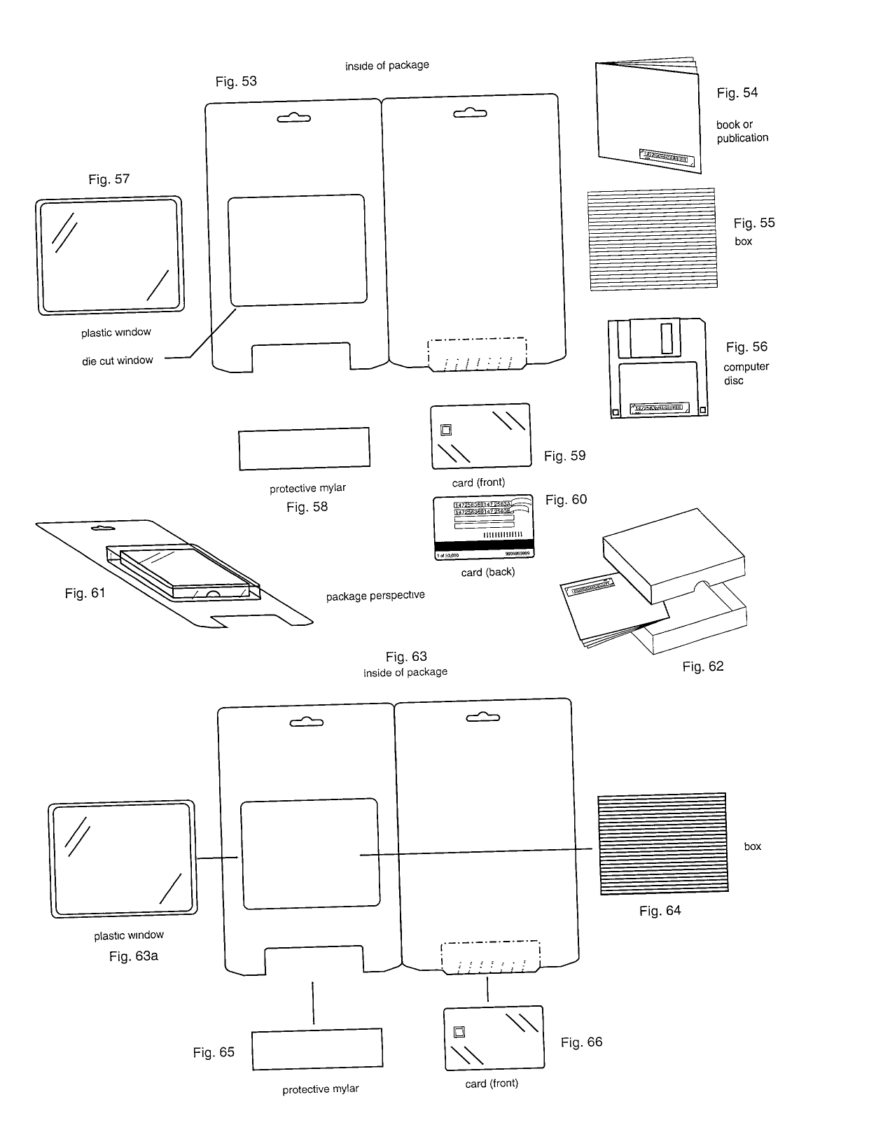

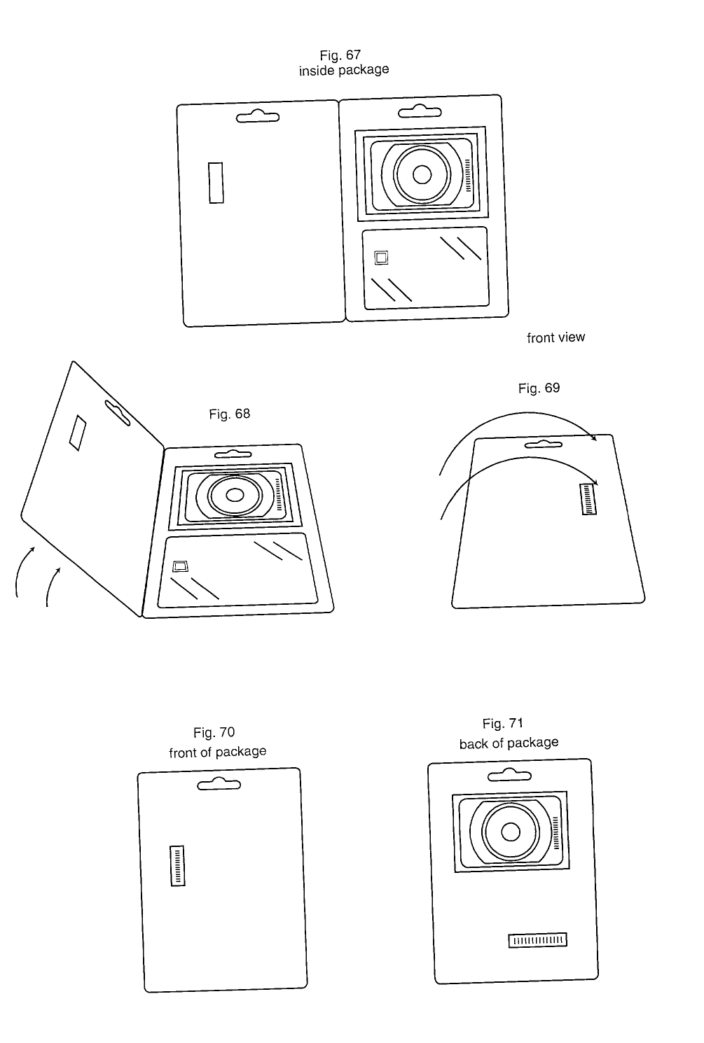

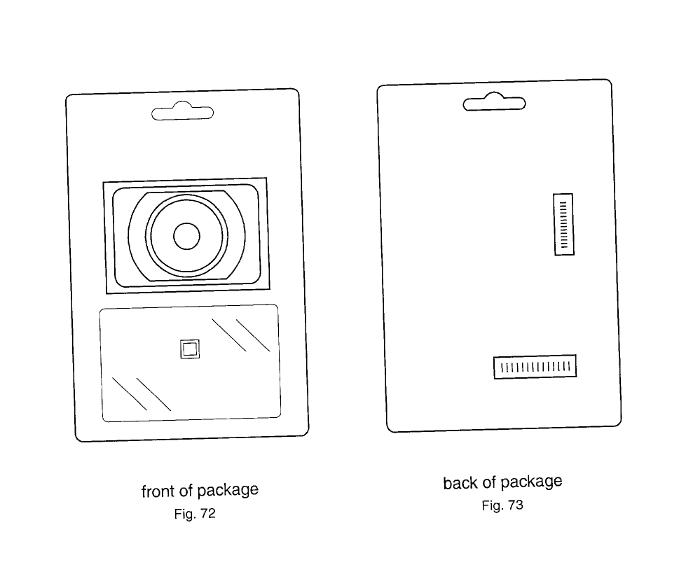

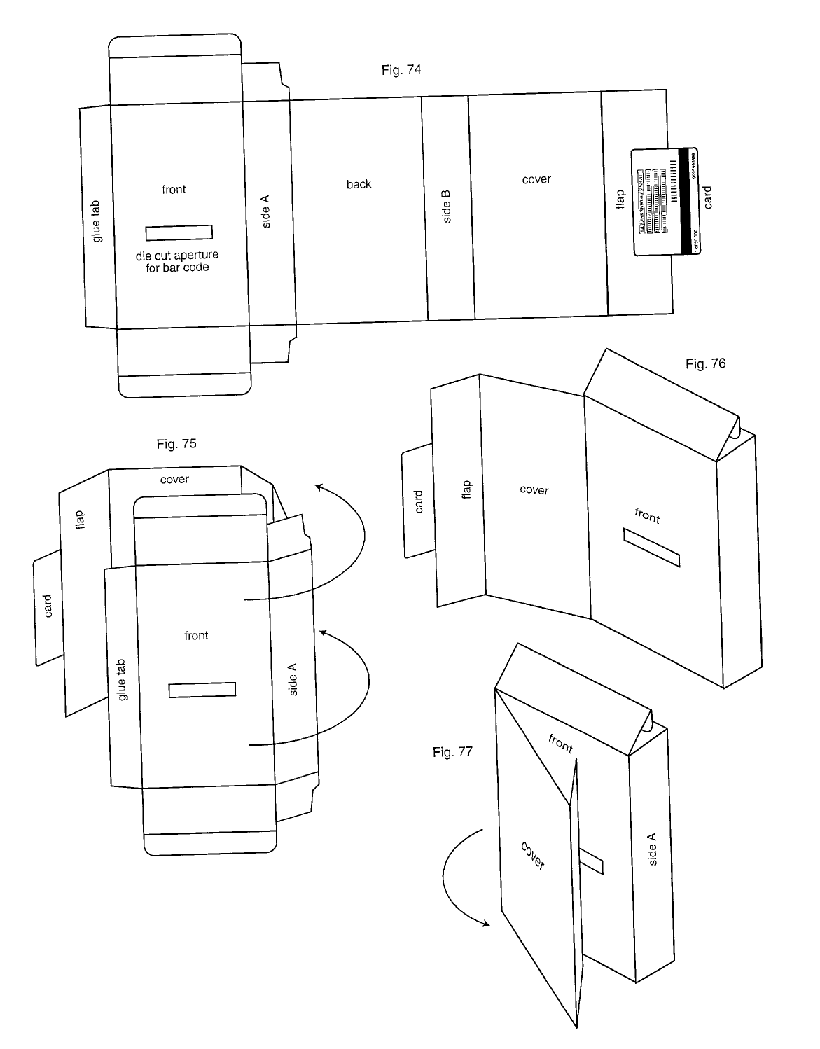

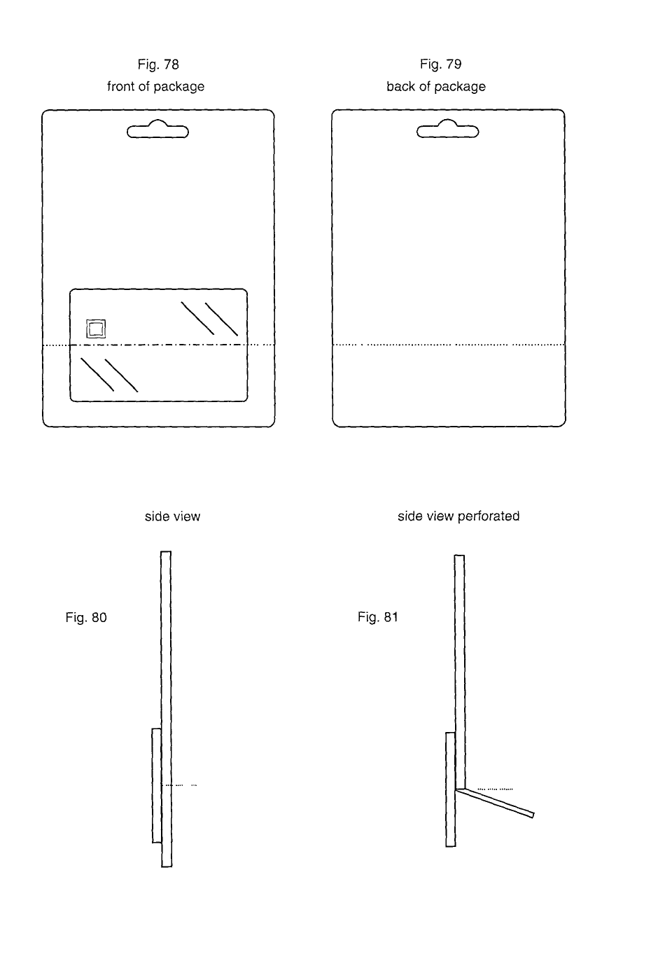

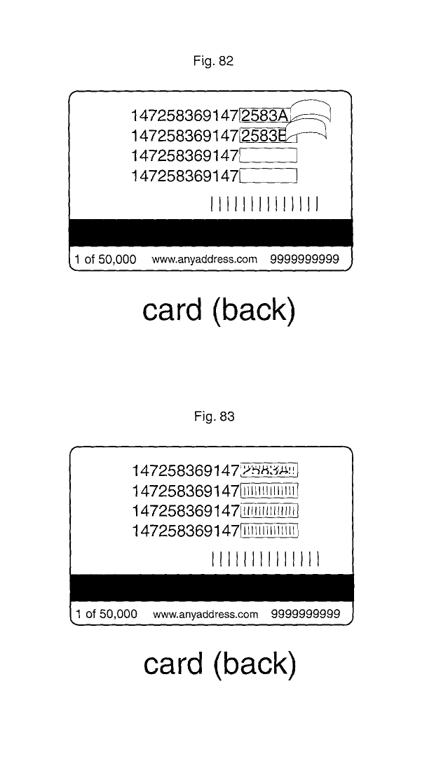

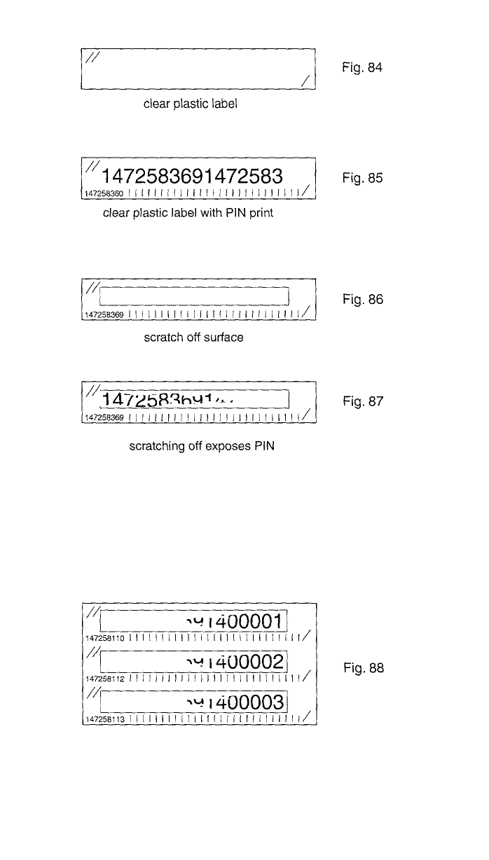

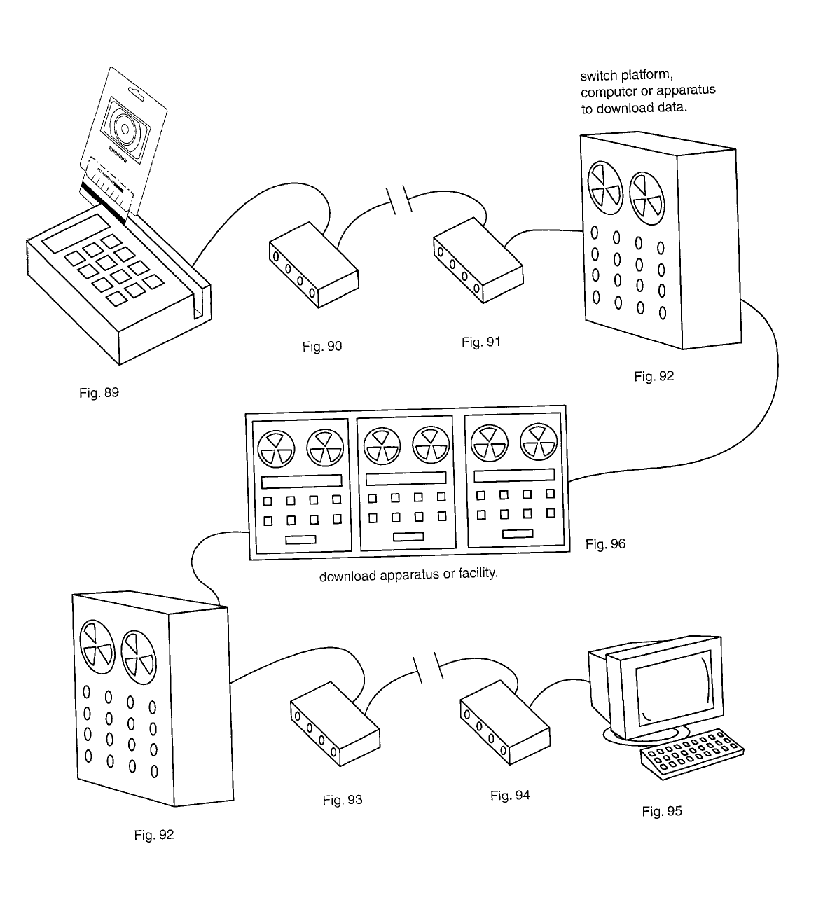

Referring to FIGS. 1-96, various preferred embodiments of the invention are shown and aspects thereof will now be described.

Package Delivery System Design

The package can be defined as anything in the invention other than the card, CD, disk, publication or manual, PIN or PINs or other related components.

The package can be any geometrical size with an attached card. The card is attached to the package in such a way that the magnetic strip can be swiped or the bar code scanned or the chip processed by a device at point of purchase prefereably without requiring the package to be torn, opened, or destroyed. The package or portion of the package or billboard other than the card is used for providing graphics for advertising or product identification. It can include a hanger hole or an aperture used to hang or present the delivery system in the retail environment, but such a hanger hole or apterture is not required. The packaged delivery system can be placed in containers or hung in racks at the point of purchase in any way that eliminates the necessity for the hanger hole or aperture. The ability to provide point-of-sale graphics that present and describe the product to the consumer is a principal feature of this package delivery system. Previously, cards contained alone (without graphic or printed packaging) have been hidden or locked securely away at retail outlets to discourage theft. Therefore, this invention or system can be displayed in any location without concern over the loss or theft of the full value of the product offered for sale. The package includes a card and/or any number of related cards. The package can include a CD, publication, as well as any other related component. The package may be either a single ply or a double ply or more. The CD, publication, disk, or other related components are secured to the package by using any commercially available adhesive, tape, window film, or shrink-wrap. The adhesive will be determined by the residue remaining on or damage to any components attached to the package including the material's ability to hold the component in place. The preferred adhesive used for effective adhesion, efficient application and shear strength is a pressure-sensitive hot-melt adhesive. This adhesive is readily available in the market and has very little residual effect on components contained in the package. Tape may be used to attach components to the package. The kind of tape, or adhesive on the tape, can be determined by the residue remaining on or damage to any component attached to the package after being removed from the invention or system. Included in the decision of what kind or type of tape used to attach the component is their application properties and associated costs. Tape may overlay and extend beyond the perimeter of the component and adhere to any portion of the package material. A pressure-sensitive label with a heat-activated PVC coating may be used to affix the card, or any other component, to the package. The pressure-sensitive label may extend beyond the perimeter of the card or the component. The package may also include a box or container that holds any promotional components related to the goods or services promoted by the packaged delivery system. The promotional items may include, but are not limited to, printed collateral materials like a map, CD, greeting cards, game related toys, or coupons. The package can have an aperture or apertures to allow a bar code to be visible for bar code scanning within the perimeter of the package. This die-cut aperture allows any bar-coded component, including the card, to be scanned and the PIN or PINs activated. The package can use PVC or other plastic or composite material to form a blister or pocket to contain a CD, publication, disk, card or any other related component. The formed blister, containing any components related to the product, can be sandwiched between two or more plies of the package material to attach the blister flange to the package. Use of PVC-based heat-activated material applied to a surface of the package will attach the blister flange to the package surface using heat and pressure to activate and seal the blister flange to the PVC coating. The blister may be transparent to allow scanning a bar code on any component contained and related to the product. Alternatively, the blister may be opaque with a die-cut aperture to allow scanning the bar code on any component related to the package delivery system. The blister may be joined to a panel of the package by using a radio-frequency sealer to bond the blister flange to the surface of the package. Any similar adhesive to those previously described can be used to attach the blister flange to the surface of the package so as not to damage any components. The package can be any geometrical design with a card attached, such that the card can be scanned or the magnetic strip read preferably without tearing, opening, or destroying the package delivery system. The package can be one or more plies of any material. The card can be attached to the package such that the package or panel can be folded at a crease, cut score, perforation, or package or unit bent to allow a magnetic strip to be read by a magnetic strip reader or a device or chip reader without removing the attached card.

Personal Identification Number (“PIN”)

“PIN” can be interpreted to mean a single PIN or multiple PINs in all or most cases.

A PIN number can be alphanumeric data of any length. A PIN number represents one unique account. PIN numbers can be produced by a computer platform in random order and specified character lengths. Random PIN numbers can have an associated sequential control number that is determined by a platform or computer creating the relationship in the PIN file. The number of characters in the control number is determined by the number of PINs in the PIN file. Each added character to the PIN affords an additional level of security. A PIN number has a predetermined sequential control number with a direct one-to-one relationship to the account. The control number can be encoded in the magnetic strip or in a bar code on the card or related components, and this additional step can be used as a means of encrypting the PIN account number.

Some PIN numbers are separated by dashes to aid the user.

Example: 999-999-999

The PIN or PINs on the card are obscured by the panels of the package delivery system or by a pressure-sensitive label with an opaque removable material that can be removed by scratching to see the PIN or PINs. The opaque material provides a level of security by providing the customer with evidence of tampering. If the obscuring material were to have been tampered with, the customer would realize that the PIN or PINs are no longer secure. This opaque scratch-off material can be transferred over the PIN on the card by heat and pressure using commonly-available hot stamping material. It can be printed in a slurry or screen-printed directly over the secure alphanumeric PIN. The opaque material can be over-printed with instructions to consumers to remove material obscuring the secure PIN. The pressure-sensitive label is then positioned over the secure PIN or PINs in a machine process at high speeds. An opaque pressure-sensitive permanent-adhesive label, cut or scored to allow evidence of tampering, can be used to secure and conceal the data. A label can be printed with information describing to the user how to notice if the underlying data or PIN has been tampered with.

Goods and Services or Downloaded data

A feature of the invention is its ability to present products in the retail environment in a cold or inactive state for activation at the time of purchase. The packaged delivery system allows a variety of goods and services to be metered or activated after the goods or services have been purchased. Goods and services suited for this invention, but not limited to, are software programs, software applications, digital information, access to digital information and programming, virtual programs, and Internet services, all of which require license control or where prepayment would benefit the supplier of the goods or services.

All of the above goods and services can be presently purchased with credit cards and delivered to computer hard drives by use of the common means of communications. A feature of the invention is that many consumers are not willing to offer confidential information to unknown organizations or merchants. The invention offers a method of purchasing goods and services with anonymity and without having established credit.

Point of Purchase

The invention provides an encoded magnetic strip, a barcode, or smart chip, any of which can be read by an appropriate device at point of purchase. The smart chip technologies are well known and can include programmed information that is either random-access memory or read-only memory, or both. The smart chips are attached or embedded into the plastic card and can be read, or information provided, with an appropriate device. An appropriate device or devices reads the magnetic strip, chip or barcode at point of purchase and transmits to a platform or facility the provided control number and/or other data related to the PIN or PINs and/or associated with the smart chip. Once transmitted, the control number(s) or data related to the PIN or PINs are activated at the platform or facility. The receipt of the transaction is then sent to the verification or authorization entity. The transaction is verification that the purchase has taken place and that the smart chip, goods or services are available for use or delivery. Once authorized, the downloaded or delivered information, software file, programs or codes are delivered by a facility and transmitted by a communications device. The information sent is then received by a device that allows the use of the goods or services purchased.

Graphic Presentation

This feature of the invention is a communication billboard to present graphic, visual and informational text to the consumer. The billboard is all that is not considered to be the card. The billboard includes the area that contains the related components. The billboard is useful to the consumer by its ability to communicate any number of features, benefits, and loyalty branded coupons to the marketplace.

Bar Codes

The card can contain a bar code that can represent the control number in a similar fashion as the magnetic strip. The bar code would contain data that allows the activation process to begin through an appropriate device. The host system would send the data to the platform after being processed by the host system and would then activate the PIN or PINs in a similar fashion as the magnetic strip. The bar code can be scanned on the card outside of the perimeter of the package or on the card within the perimeter of the package through a die-cut aperture or a transparent film window or blister. Related components to the PIN are included in the package and can have a bar code to create the numeric relationship in the manufacturing process.

Magnetic Strip, Barcode or Codes, Chip

The invention utilizes a magnetic strip, and/or a bar code or codes, and/or chip or chips, all of which provide information to appropriate devices at the point of purchase for activation and/or delivery of good and services. The magnetic strip, bar code, or chip are not required to be on the card and may be applied to the package or component of the package using commonly available tape, adhesive, magnetic tape, bar code pressure-sensitive label or labels with or without magnetic properties, or printed bar code or codes, or a dry offset printing applied magnetic slurry. The magnetic strip, bar code, or chip can be encoded on one or more of the available tracks, codes, chip features included in data processing. These different tracks, or codes, or chip features can be used for multiple purposes such as activation of an account and/or metering an account. The magnetic strip, bar code or codes, or chip are accessible to be read by the appropriate devices at the point of purchase without opening, tearing or destroying the package.

Magnetic Strip Encoding

The magnetic strip can be either laminated to the exterior of a laminated plastic card in a process commonly known to the industry. This laminating process technology can be purchased from card manufacturing equipment producers. The magnetic strip can also be rolled onto the surface of a plastic card or a card of any material. The materials and equipment used to roll on the magnetic strip onto the surface of a card are similar to a hot stamping process where hot stamp material is applied to a surface passed under a hot wheel the same width or thickness as the magnetic strip it will produce. The hot wheel activates a heat-sensitive adhesive, which bonds the magnetic material to the card or package material. As the magnetic material is glued or bonded to a surface it is pulled away and separated from the release paper or film used to deliver the magnetic material to the hot wheel and intended card or packaging material. This can also be provided by card manufacturing company. The magnetic strip can be applied on the card using a magnetic tape pressure-sensitive label. The magnetic strip can be applied to any material that the card and/or the package have been manufactured or produced. Depending on the quality of the magnetic strip, production methods or application techniques will be determined by the magnetic strip's ability to be read at time of purchase. Presently the cost and the process used to manufacture a card with a magnetic strip are based on the anticipated number of transactions that the magnetic strips are intended to initiate. A secure means of providing data to the platform or server is to encode a sequential or a random control number that is equal to or assigned to the PIN or PINs. This “PIN to control number” relationship is created with a computer, platform or other device. Once the relationship is created, the control number is written to the magnetic strip with additional data strings that provide other types of information. Other types of information on the magnetic strip include data that directs the transmission to its destination and also data that provides the retailer or the manufacturer information about the kind of sale and the product sold. The process to write the encoded information to the strip is commonly known to the industry and is accomplished by machines that write the programmed information to the magnetic strip during the personalization process. The direct relationship established in a computer or platform between the control numbers and the PIN or PINs allows the information encoded on the magnetic strip to be different than the obscured PIN or PINs. This difference secures the PIN or PIN numbers from being discovered by someone in possession of a device that can read the magnetic strip. This helps ensure that if the magnetic strip is read by a means other than were intended, information would be useless. This becomes important as the magnetic strip is outside of the perimeter of the package and can be read or accessed without any evidence to the purchaser. Someone with PIN file information and the equivalent control numbers would be capable of using the actual PIN or PINs for their purpose. However the additional requirement at registration of providing one or more numbers or codes on other components, lessen the ability of the delivery of the good or service.

The Card

The attached card can be plastic, laminated plastic with two or more layers, a single piece of material such as plastic, paper, or any other combination of materials or composites. The card is attached by the use of any adhesive or tape available on the market today. The front of the card can be attached to the front or the back of a panel. The back of a card can be attached to the front or back of a panel. The card can be any geometrical size or thickness that can include an obscured PIN or PINs, a magnetic encoded strip, a bar code or bar codes, a computer chip, or human-readable data capable of being read by a device or scanner. The card can also have a telephone number or a web address used to initiate delivery of the purchased product. The computer chip can be mounted or embedded into or on the card. The card may have a label or labels that contain an obscured PIN or PINs that are either the same or different as the PIN or PINs which are obscured and on the card or in the package. A bar code may be used to identify the obscured PIN or PINs on the labels. The card and package can be produced so that the same material is used to manufacture the delivery system. The card is perforated or cut scored to allow the card to remain attached to the billboard or package. This manufactured version of the delivery system includes a magnetic strip, label or labels with or without an obscured PIN or PINs, and other human-readable data including having a barcode or barcodes. This design allows the purchaser, with little effort, to detach the card from the billboard graphic or informational portion of the package. This design may have a hanger hole but it is not required. The billboard portion of the design can provide room for attached components related to the PIN or PINs in a similar fashion as described previously. A web address, providing the consumer information and instructions that initiates the delivery of the goods and services purchased, can be provided on the card. The card has an access telephone number that is used for customer service or metered technical service however the access number is not required to be on the card.

Packaged components

A feature of the invention includes enough area on the billboard to contain related components of the provided goods and services. Related components not limited to may include a CD or CDs, CVD or CVDs, publications, collateral printed materials, gift box or boxes with card or cards. The components can be attached to the package using transparent PVC blister to seal the blisters to the heat-sealed adhesive coating on a surface of the package or billboard, thereby creating a pocket to contain one or more components in position or between one or more plies of the package or billboard. A bar code and related human-readable number can be visible and used to associate any component to the card in the manufacturing process. The coded data can be visible through an aperture within the perimeter of the billboard, or formed blister. The coded data can be visible through the transparent PVC blister.

Point-Of-Sale Activation Device

A hardware device at the point of purchase capable of producing a PIN or PINs that can initiate the transfer of electronic data similar to that described previously. The device has the ability to be preloaded or connected to an apparatus or system that can generates random or sequential PIN or PINs. The PIN or PINs after being generated are printed on any material at point of purchase and exchanged for payment. The PIN information is known previously or provided to the system after being created at point of purchase. The PIN or PINs can then initiate delivery of the purchased goods or services by presenting the secure PIN or PINs to the appropriate device or website. Any information or graphic representation provided at the point of purchase by a device or apparatus that provides a portion or portions, codes, or encrypted codes of the goods or services required for any product to be functional after purchase and authorization.

A kiosk can be programmed to print a PIN or PINs after being purchase by a customer. The PIN or PINs can be preprogrammed in the device and delivered to the customer at point of purchase.

Cold Inventory

A feature of the invention provides less than the entire amount of the goods and services such that the product is non-functional before being purchased.

Or, goods or services requiring a code produced by any combination of the PIN or PINs or serial number, either obscured or visibly obvious, may be included on or in one or more of the components on the delivery system or computer.

Hot Inventory

A feature of the invention providing the portion or portions, codes, or encrypted codes of the goods or services required for the product to be functional after purchase and authorization.

Method of Validation

A feature of the invention provides the association between the obscured PIN or PINs with data on any related packaged components, and/or a serial number or numbers of the destination apparatus, device or computer receiving the delivered goods or services. A particular number or numbers provided on the related components is required as well as the PIN or PINs to authenticate the purchase of the product. The PIN or PINs are obscured by different methods common to the industry to provide the customer with evidence of tampering. The feature of obscuring the required PIN or PINs or serial numbers assists the customer in using un-tampered with products.

Clickless CD Related Component

A feature of the invention can include a computer disk (CD) that, after installation in a CD drive, initiates direct contact to a website used to authenticate the delivery of purchased and licensed goods and services.

Purchaser uses the provided CD included in the package by inserting into a CD drive to access the download apparatus or facilities website. The CD provides the website with associated CD serial number(s) and purchaser is asked to provide obscured PIN or PINs to authenticate predetermined CD serial number(s) and PIN or PINs association. Upon receipt of activated PIN or PINs with predetermined associated CD serial numbers, authentication initiates the resulting delivery of purchased data. Interaction with a facility or apparatus at the time of download provides an identification number unique to the computer, such as the hard drive serial number and/or MAC address of the computer, to the facility or apparatus to be used as additional authentication for future customer service and technical support as well as additional limited download requests.

Method of Activating a Smart Card (Chip)

A feature of the invention allows the activation for use of the smart card or chip at the point of purchase. A computer chip can also be included in the card and can have serial numbers to provide a relationship to the PIN or PINs, similar to the other related components of the delivery system, providing addition authentication to the provider of the a goods or service licensee. The chip can be used to store a license number or serial number as well as to record the number of downloads associated with a license. The chip can provide authentication or additional authentication when chip readers are built into the computers or through peripheral devices. The magnetic strip on the card contains an alphanumeric string relating to the PIN and serial numbers and is swiped in a device such as a Verifone at the point of sale. The alphanumeric string is sent to the platform or switch to activate the PIN account. The PIN account is directly related to the serial number or identity of the chip. When the valid PIN is received at the platform or switch, the associated chip is also then activated and capable of being used. A website is contacted for registration and/or authentication, and the chip-associated account is checked for authentication prior to download of any software or activation codes. The authenticated card with chip are then capable of providing an access key to programming, entertainment, virtual games, educational material or classes and any other digital product requiring a fee or license Or pre-purchase. Other types of products that could be used or accessed by the authenticated card and computer device are special events, entertainment products, streaming video or audio, music or concerts, or any goods or services available through a PC with the use of a valid smart card packaged and activated by this invention at the point of sale.

Manufacturing Process

A method of associating the components in manufacturing is by scanning the data or barcodes on the related components and then relating the data to the information provided by the encoded magnetic strip, bar code, and/or chip. The bar codes are visible through the transparent PVC or through a die-cut aperture within a panel or panels of the package. The card or the package provide information to allow a method of access to the appropriate website or apparatus for registration and/or authentication. Once the website or apparatus has been contacted, entering the PIN number as well as a serial number or other information provided on the package and associated with the PIN or PINs and/or related component, authentication or purchase is proven. A unique serial number can be included in the information provided by the CD. The CD's unique serial number is then identified by a bar code and human-readable text. This serial number can then be used in a mathematical formula for the creation of a code number required each time the goods or services are used. A CD with a clickless web-access feature is available for easily accessing the registration website. Should the auto-access feature be left out or not included in the CD, a web address or telephone number can be provided on the card or package or component. The serial number on a related component can be printed on the component using a bar code printed, for example, by an ink-jet printer, so that associated human-readable numbers are random Or serialized. The serial numbers are captured during the manufacturing process. The card will include the appropriate web address or telephone number to authenticate and initiate delivery of the goods or services. Also included on the card is a toll-free telephone number supplied by the software manufacturing concern to meter or measure the time and frequency and/or amount of technical service provided with the purchased product. The card includes an exposed data-encoded strip and the card preferably has a PIN or PINs thereon. The package includes a first panel and a retaining means that secures the card to the first panel so that, when the card is secured to the panel, at least a portion of the data-encoded strip is preferably exposed and outside and remote from the panel so that the magnetic strip can be swiped by a device at the point of sale, preferably without having to remove or unwrap the packaging material. The data-encoded strip is encoded with a control number that is associated with the metered or open account. The package also comprises an attached serialized CD or publication. The serial number or numbers contained in the package can be associated with the PIN or PINs affixed to the card. When the card is purchased, the control number is read from the data-encoded strip while the card is secured to the first panel, and the metered account or open account is activated at the point of sale. Then the platform or apparatus records time of sale and activation reporting data to server or apparatus or facility.

Software or Goods and Services License control

The ability to control and enforce the copyright of software manufacturers and providers of digital information and entertainment continues to be of great importance to the industry because complete control and enforcement would allow the actual price charged per unit to more closely relate to the value of the product. No longer would the buyers of a software program or digitally-downloaded product be paying for all the pirated products in the marketplace.

Once the website or apparatus has been accessed, product registration can take place. A PIN or PINs can be required, as well as additional information or numbers provided on or in the components or packages, to complete registration. Upon receipt of the required information requested, or at registration, a numeric algorithm creates a unique number from the data provided by the PIN and component numbers, or any combination the related data, and can be embedded into the data or software program or goods and services to allow full use of the product. The unique number or key can be visibly obvious or hidden so that the user is aware or unaware of the existence of the unique number or key or operating code. The unique number allowing the full use of the goods or services can also use the serial number or unique number associated with the hard drive or the computer to which the goods or services are delivered. This unique number associated with the hard drive or computer operating system would then be required to use the allowed, or full use or the value of the goods or services delivered. The unique code or algorithm can remain a required element to operate the product stored or in the software program or goods and services, or remain on the hard drive or computer for the life of the product. This element can be used to discourage the transference of the software program, goods or services to a different computer by any means used to transfer digital information today such as computer-to-computer file transfers. The concept of additional PIN or PINs is the tool that allows for additional authorized downloads or re-registration. The additional PIN or PINs can be used to download one or more songs, or book chapters, or any other part of a complete work or special event. Those PIN or PINs represent an unused account that has been simultaneously activated at the point of purchase and is capable of initiating the delivery of product at any predetermined point of time in the future. The numeric association applied or included on one or all of the related components can be requested at different intervals in the life or term of the product purchased. This feature would require the components to remain together or with the card for future use of the service provided by the invention.

Method of Activating a PIN

A method of activating a metered or opening an account that is associated with a PIN number or several PIN numbers, where the personal identification number or numbers are affixed to the card, and an apparatus comprising a package adapted for holding the card. The method used to secure the card to the package is that of a glue or adhesive, either cold- or hot-melt, or both. The card and package can be the manufactured from the same material, and the card remains attached to the package by a cut score or perforation or a printed cut instruction and, after purchase, can be detached from the package by the purchaser using force, scissors or a knife. The card can be secured between the first panel and the second panel and secured to either the first or second panels. By use of a PVC heat-sensitive coating, the PVC card can be glued or bonded between the panel or the inside surface or surfaces by application of heat and pressure to activate the heat-sensitive adhesive. Included in or on the package is a CD or CDs. The CD or CDs are attached to the package. A transparent PVC blister is used to seal the blisters to the heat-sealed adhesive creating a pocket to contain one or more CDs in position. A bar code, with or without a human-readable serial number on the CD and visible through the transparent PVC or aperture, is used to identify and associate the bar code or data with the data on the magnetic strip, bar code or obscured PIN or PINs on the card. The association of the data on the card and the CD, or any other related component, is accomplished in the manufacturing process by scanning the codes on the related components and capturing the data in the production database during manufacturing. The relationship of the data allows activation at the point of purchase and authorization of the delivery of goods and services at the time of registration. The bar codes are visible through the transparent PVC or through a die-cut aperture within the first panel or the second panel. The invention can provide a means to access the appropriate website for registration and authentication by entering the PIN number as well as a serial number associated with the CD or publication. Supplying a predetermined serial number on the CD or publication further authenticates the predetermined association of the PIN and serial number made in the manufacturing process. The serial number that is associated with the CD is written at the same time the information or programmed software is built into the disk. The serial number on the publication could be printed on the publication using an ink-jet printer so that the numbers are random or serialized. The serial numbers captured in the manufacturing process for the card will include the appropriate web address in case the auto-access feature is left out or not included in the CD. Also included on the card is a toll-free telephone number supplied by the software manufacturing concern to meter or measure the time and frequency and/or amount of technical service provided with the purchased product. A computer chip can also be included in the card and can be used instead of or as well as the serial numbers provided with the CD or CDs and/or publication providing addition authentication to identify the purchaser or licensee. The chip can be used to store a license number or serial number as well as to record the number of downloads associated with the license. The chip can provide authentication or additional authentication when chip readers are built into the computers or through peripheral devices. The magnetic strip on the card contains an alphanumeric string relating to the PIN and serial numbers and is swiped in a device such as a Verifone at the point of sale. The alphanumeric string is sent to the platform or switch to activate the PIN account. When the website is contacted for registration and authentication the PIN-numbered account is checked for activation prior to download of any software or activation codes so that the method of present invention can be practiced.

Hardware Device Used for Transaction

Presently, hardware devices used at the cash register for Visa, MasterCard, Discover, and American Express are being employed to transmit data. The future will allow merchants and retailers both to use magnetic strips and smart chips to transmit data to verify a purchase. Verifone is a brand name for well-known hardware devices at the retail checkout lanes. Other companies, like NCR and AMEX, are also in the business of providing hardware devices designed to perform different types of data transmissions at retail checkout lanes. A feature of the invention is that, at the time of purchase, the delivery system is activated by a transaction device. This device provides, to the intended recipient, information about the purchase, the time of purchase, and the amount of the purchase. This feature can provide the manufacturer or software producer with real-time retail inventory numbers outside of the host systems presently providing different versions of electronic data interface (“EDI”) to suppliers.

Although the present invention has been described and illustrated with respect to preferred embodiments and a preferred use therefor, it is not to be so limited since modifications and changes can be made therein which are within the full intended scope of the invention.

What is claimed is:

1. A packaged delivery system for point-of-sale activation of products or services to be delivered, said packaged delivery system comprising:
a package;
at least one component related to the products or services to be delivered, said at least one component being retained within said package when said package is in a closed position;
a card secured to said package, said card having a data-encoded portion, said data-encoded portion being displaced relative to said package whereby said data-encoded portion is exposed and accessible at the point of sale of the products or services to be delivered, said data-encoded portion including data that allows the activation process to begin through a point-of-sale activation device;
wherein said data is associated with the products or services to be delivered.

2. The packaged delivery system as recited in claim 1, wherein:
said data-encoded portion of said card includes a unique control number; and
said card further includes a personal identification number applied to a surface of said card, said unique control number and said personal identification number being associated with one another and with the products or services to be delivered.

3. The packaged delivery system as recited in claim 1, wherein:
said package includes a first panel and a second panel attached to said first panel, said first and second panels being in substantially congruent relationship with one another when said package is in a closed position.

4. The packaged delivery system as recited in claim 3, wherein:
said package further includes a pocket secured to one of said first and second panels;
said at least one component related to the products or services to be delivered is retained within said pocket when said package is closed, said at least one component being removable from said package when said package is open.

5. The packaged delivery system as recited in claim 4, wherein:
said card is secured to said one of said first and second panels.

6. The packaged delivery system as recited in claim 4, wherein:
said card is secured to the other of said first and second panels.

7. The packaged delivery system as recited in claim 1, wherein:
said at least one component related to the products or services to be delivered is selected from the group consisting of: a CD, CDs, a CVD, CVDs, publications, collateral printed materials, a gift box containing at least one additional card and gift boxes, each containing at least one additional card.

8. The packaged delivery system as recited in claim 1, wherein:
said data-encoded portion of said card is a magnetic strip.

9. The packaged delivery system as recited in claim 2, further including:
tamper evident means for providing an indication if said personal identification number is secure.

10. The packaged delivery system as recited in claim 9, wherein:
said tamper evident means is an opaque scratch-off material obscuring said personal identification number during display of said packaged delivery system.

11. The packaged delivery system as recited in claim 2, wherein:
said personal identification number is obscured by said package when said package is closed.

12. A packaged delivery system for point-of-sale activation of products or services to be delivered, said packaged delivery system comprising:
a package;
at least one component related to the products or services to be delivered, said at least one component being retained within the package;
a card secured to said package, said card including a personal identification number applied to a surface of said card, said personal identification number being associated with the products or services to be delivered;
a unique control number being associated with said personal identification number and the products or services to be delivered, said unique control number being encoded on one of said package, said card and said at least one component related to the products or services to be delivered.

13. A package for use in a packaged delivery system for point-of-sale activation of products or services to be delivered, the package adapted for securing a first card thereto and for retaining at least one component related to the products or services to be delivered, the first card including a personal identification number related to the products or services to be delivered, said package including:
a first panel;
a second panel attached to said first panel, said first and second panels being in substantially congruent relationship with one another when said package is in a closed position;
means for retaining said at least one component related to the products or services to be delivered within said package when said package is in a closed position, said at least one component being removable from said package when said package is in an open position;
means for securing said card to one of said first and second panels.

14. The package as recited in claim 13, wherein:
said means for retaining is attached to said one of said first and second panels.

15. The package as recited in claim 14, wherein:
said means for retaining is a pocket.

16. The package as recited in claim 13, wherein:
said means for retaining is attached to the other of said first and second panels.

17. The package as recited in claim 16, wherein:
said means for retaining is a pocket.

18. The package as recited in claim 13, wherein:
said first panel is bonded to said second panel when said package is closed.

19. A method of activating delivery of goods or services at the point-of-sale, the method comprising the steps of:
(a) associating a personal identification number with goods or services;
(b) associating a number with said personal identification number;
(c) using a point of sale activation device to transmit said number to a processing apparatus;
(d) activating said personal identification number by said processing apparatus; and
(e) then activating delivery of said goods or services by said processing apparatus.

20. The method of claim 19, wherein said number is selected from the group consisting of: a control number, a serial number and an identity number of a chip.

21. The method of claim 19, wherein said number is encoded on a data encoded strip.

22. The method of claim 21, wherein said data encoded strip is selected from the group consisting of: magnetic strip, bar code, or chip.

23. The method of claim 21, wherein said data encoded strip is on a card.

24. The method of claim 21, wherein said data encoded strip is on a package.

25. A method of using a number encoded on a package to provide point-of-sale delivery of goods or services, the method comprising the steps of:
(a) associating a number with goods or services;
(b) encoding said number on to a package;
(c) then using a point-of-sale activation device to transmit said number to a processing apparatus;
(d) then activating said number by said processing apparatus; and
(e) then activating delivery of said goods or services by said processing apparatus.

26. The method of claim 25, wherein said number is encoded as a bar code.

27. The method of claim 25, wherein said number is selected from the group consisting of: a control number, a serial number and an identity number of a chip.

28. The method of claim 25, wherein the number encoded on said package is obscured with tamper evident means comprising a sticker affixed to said package.

29. A method of delivering a product to a buyer from a provider that facilitates licensing control of the product; the method comprising:
(a) associating a personal identification number with a product;
(b) encoding said personal identification number on to a data encoded strip;
(c) then using a point-of-sale activation device to activate said personal identification number;
(d) providing said buyer with said personal identification number;
(e) providing said identification number from said buyer to a provider;
(f) requesting product registration by said provider from said buyer;
(g) receiving product registration by said provider from said buyer;
(h) creating a unique identification number associated with a buyer's computer program, said unique identification number being required to access said product;
(i) embedding said unique identification number into said product; and
(j) delivering said product with said embedded unique identification number.

30. The method of claim 29, wherein said product registration includes the serial number of a buyer's computer.

31. The method of claim 29, wherein said product registration includes the serial number of a buyer's hard drive.

32. The method of claim 29, wherein said product is software.
